(19) United States
(12) Patent Application Publication
(10) Pub. No.: US 2013/0291010 A1
(43) Pub. Date: Oct. 31, 2013

(54) METHOD OF INSERTING VIDEO ADVERTISEMENT IN WEB PAGE

(71) Applicant: GUOSHI PARTNERS CO., LTD., Taipei City (TW)

(72) Inventors: YU-HUI YEH, Taipei City (TW); TIEN-SHUI KAO, Taipei City (TW); CHIN-YANG KUO, Taipei City (TW)

(73) Assignee: GUOSHI PARTNERS CO., LTD., Taipei City (TW)

(21) Appl. No.: 13/870,624

(22) Filed: Apr. 25, 2013

(30) Foreign Application Priority Data
Apr. 26, 2012 (TW) 101114990

(51) Int. Cl. H04N 21/43

(52) U.S. Cl. CPC H04N 21/43
USPC 725/32

(57) ABSTRACT

A method of inserting video advertisement in a web page is provided, including steps of: sending a web page browsing signal via a client to a web page server, thereby allowing the web page server to provide web page information to the client; sending an advertisement connection signal via the client to an advertisement server when the client receives the web page information; searching corresponding video advertisement information via the advertisement server according to a relation condition of the web page information; and sending an advertisement generating signal to the client via the advertisement server for inserting and displaying the video advertisement information in the web page information.

### CROSS-REFERENCE TO RELATED APPLICATION

This application claims the benefit of Taiwan Patent Application No. 101114990, filed on Apr. 26, 2012, in the Taiwan Intellectual Property Office, the disclosure of which is incorporated herein in its entirety by reference.

### BACKGROUND OF THE INVENTION

1. Field of the Invention

The present invention relates to a method of inserting video advertisement in a web page, and more particularly to the method of inserting video advertisement in a web page to allow users to insert advertisement information with images into the web page when opening the web page.

2. Description of the Related Art

As information advance, users generally browse various websites (including social groups, news, and forums such as Facebook, Yahoo, PC home, UDN, Mobile01), publish discussions or leave messages by using a tool such as a personal computer, a notebook computer, a mobile phone or a personal digital assistant (PDA). However, advertisement information may affect at a fixed position (such as the center, left side, right side, upper left corner, upper right corner, lower left corner or lower right corner) of a related web page during the using process, so as to achieve the advertising effect.

In the conventional way of displaying advertisements in a web page, an advertisement display space is reserved at a fixed position of the web page and provided for displaying advertisement information. However, the advertisement information may fail to show sometimes when users open a web page, and a black screen or a message indicating a failed linkage appears at the advertisement display space of the web page and results in a poor overall appearance of the web page

In addition, the conventional advertising usually arranges a source position of the advertisement information in a web page, so that when a user is interested in the content of a web page content to open the web page, the user usually receives advertisement information that is irrelevant to the content of the web page most of the time, and such advertisement information fails to attract the user's attention and results in a low advertising effect. Although some of the advertisement information are relevant to the content of the web page, yet the advertisement information is displayed in text form corresponding with the advertisement information and cannot be shown in an audio/video form.

### SUMMARY OF THE INVENTION

In view of the aforementioned problems of the prior art, it is a primary objective of the present invention to provide a method of inserting video advertisement in a web page to overcome the problems of the conventional web page for displaying advertisement information including the failure of showing the advertisement information corresponding to the content of the web page or that the advertisement information can be displayed in text only and the web page has to reserve an advertisement display space to display advertisement information. When the advertisement information cannot be displayed, the advertisement display space still remains to be displayed in the web page.

To achieve the aforementioned objective, the present invention provides a method of inserting video advertisement in a web page, and the method comprises the steps of sending a web page browsing signal via a client to a web page server, thereby allowing the web page server to provide web page information to the client; sending an advertisement connection signal via the client to an advertisement server when the client receives the web page information; searching corresponding video advertisement information via the advertisement server according to a relation condition of the web page information; and sending an advertisement generating signal to the client via the advertisement server for inserting and displaying the video advertisement information in the web page information.

Preferably, the web page information includes an advertisement corresponding tag to allow the client to send the advertisement connection signal to the advertisement server according to the advertisement corresponding tag.

Preferably, the advertisement corresponding tag is a program code included in a source file of the web page information.

Preferably, the relation condition includes a title, a text, an image or a web page source of the web page information.

Preferably, the method of inserting video advertisement in a web page further comprises the step of sending an acknowledge signal via the advertisement server to the web page server, when the video advertisement information is inserted and displayed in the web page information.

Preferably, video advertisement information includes a movie, a video or an animation.

Preferably, the advertisement server includes an advertisement database for storing the video advertisement information.

Preferably, the advertisement server includes an analyzing unit for analyzing and comparing the relation condition to search the corresponding video advertisement information.

Preferably, when the advertisement server transmits the advertisement generating signal to the client, an advertisement display frame is inserted into the web page information and provided for displaying the video advertisement information.

Preferably, the client displays no advertisement display frame when the corresponding video advertisement information has not been found by the advertisement server.

In summation, the method of inserting video advertisement in a web page according to the present invention has one or more of the following advantages:

(1) In the method of inserting video advertisement in a web page, the web page information includes an advertisement corresponding tag, such that when a user opens web page information, the advertisement corresponding tag is linked to an advertisement server to allow the advertisement server to insert corresponding advertisement information of display videos or images into the web page information according to the content of the web page information, and allow the user to view the advertisement corresponding to the content of the web page while browsing the web page, so as to attract the attention of the user and achieve the effect of improving the overall effect of the advertisement.

(2) The method of inserting video advertisement in a web page no longer requires reserving any advertisement display space in the web page information, but the advertisement information is inserted and displayed in the web page information only when the advertisement server searches and has found corresponding advertisement information. If no corresponding advertisement information is found, the web page information will remain unchanged, and will not display a black screen or reserve a frame showing the text indicating the failure of providing advertisement in the web page information.

### BRIEF DESCRIPTION OF THE DRAWINGS

FIG. 1 is a flow chart of a method of inserting video advertisement in a web page of the present invention;

FIG. 2 is a first schematic view of a method of inserting video advertisement in a web page according to a preferred embodiment of the present invention; and

FIG. 3 is a second schematic view of a method of inserting video advertisement in a web page according to a preferred embodiment of the present invention.

### DESCRIPTION OF THE PREFERRED EMBODIMENTS

The technical characteristics, contents, advantages and effects of the present invention will be apparent with the detailed description of a preferred embodiment accompanied with related drawings as follows. It is noteworthy that same numerals are used to represent respective elements in the following preferred embodiments.

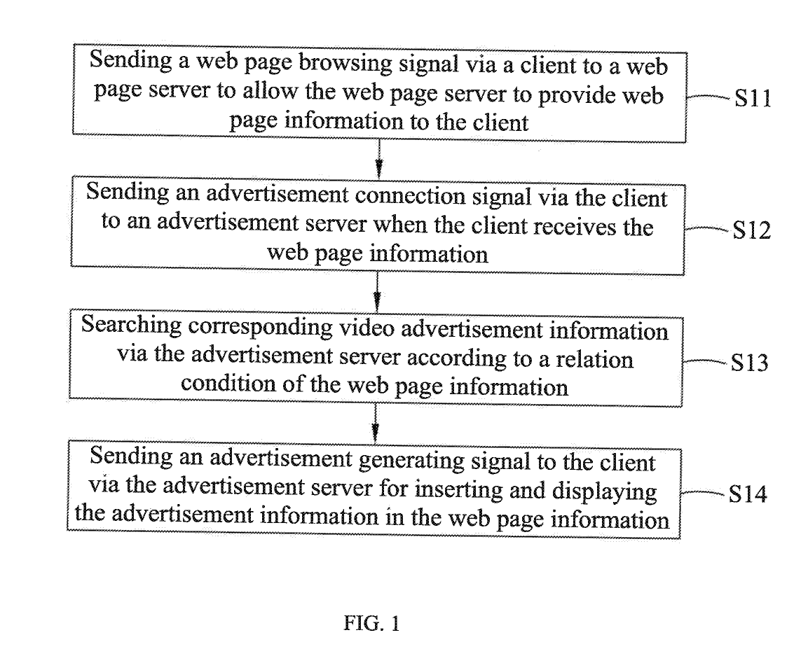

With reference to FIG. 1 for the flow chart of a method of inserting video advertisement in a web page of the present invention, the method comprises the following steps:

S11: Sending a web page browsing signal via a client to a web page server to allow the web page server to provide web page information to the client.

S12: Sending an advertisement connection signal via the client to an advertisement server when the client receives the web page information.

S13: Searching corresponding video advertisement information via the advertisement server according to a relation condition of the web page information,

S14: Sending an advertisement generating signal to the client via the advertisement server for inserting and displaying the advertisement information in the web page information.

Wherein, a program code of an advertisement corresponding tag is coded in a source file of web page information when the web page information is written, such that when a user opens the web page information from a client, the client can send an advertisement connection signal to an advertisement server according to the advertisement corresponding tag in the web page information. Provided that the advertisement server receives the advertisement connection signal, an advertisement display frame is inserted into the web page information and provided for displaying the video advertisement information. If the advertisement server has not searched and found related video advertisement information, the web page information will not be inserted into the advertisement display frame to avoid showing a black screen or an advertisement reserved frame with texts indicating no advertisement is linked in the web page information.

Wherein, the advertisement server comprises an advertisement database for storing a large quantity of video advertisement information. The video advertisement information includes movie, video or animation data. In addition, the advertisement server further comprises an analyzing unit which can be a software program or a hardware circuit chip for analyzing and comparing the relation condition in the web page information to search video advertisement information related to the relation condition from the advertisement database. Wherein, the relation condition includes a title, a text, an image or a web page source of the web page information. For texts, the analyzing unit analyzes any text in the web page information that has showed most frequently and lists such text as a keyword for searching, and then compares the text with the video advertisement information stored in the advertisement database in order to search the corresponding video advertisement information.

Wherein, when the advertisement server sends an advertisement generating signal to a client correctly, and the video advertisement information is inserted and displayed in the web page information, the advertisement server sends an acknowledge signal to a web page server to notice the web page server about the video advertisement information being inserted and displayed in the web page information, and provide an advertisement platform of the web page information to the web page server, so that an acknowledge signal can be used to confirm the frequency of displaying and inserting the video advertisement information for conducting commercial transactions.

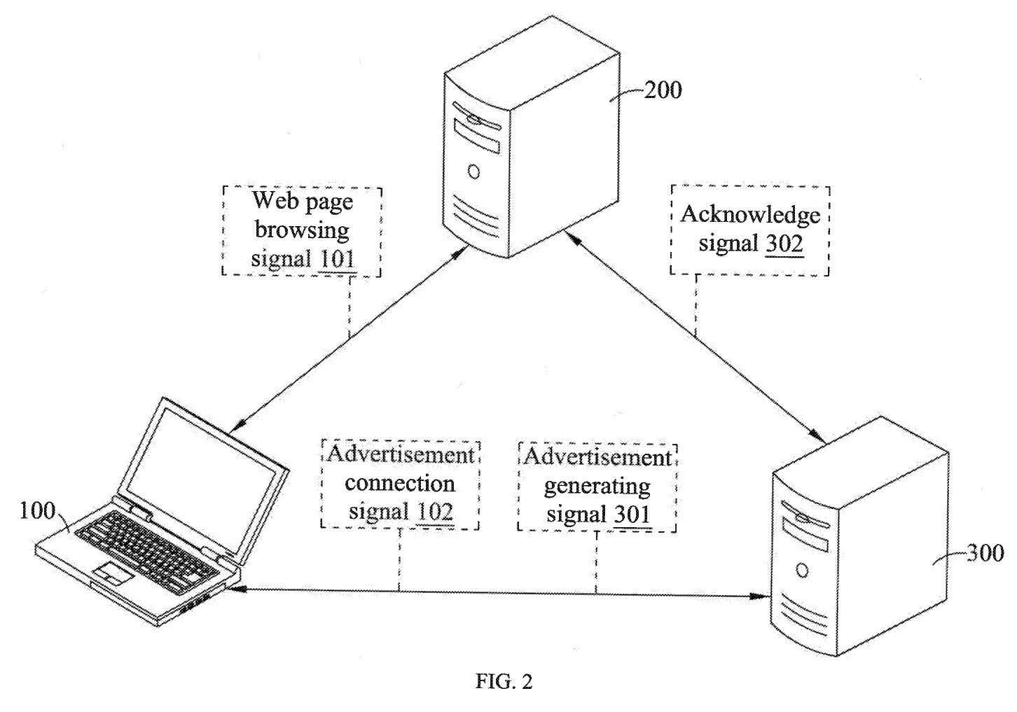

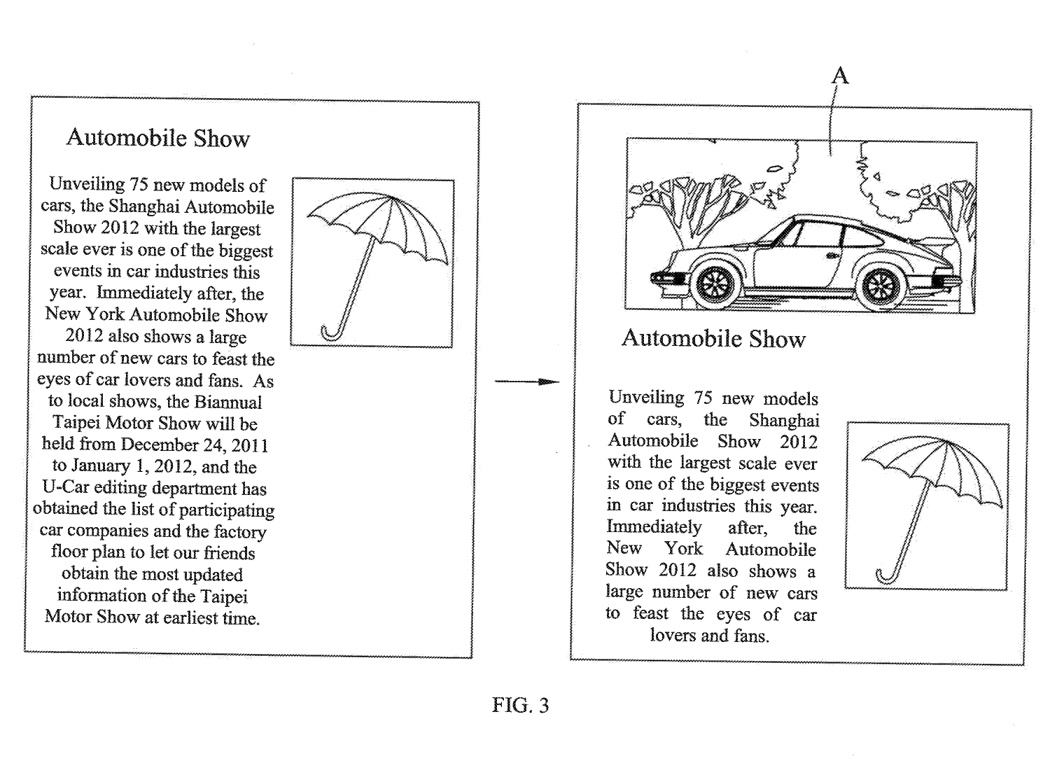

With reference to FIGS. 2 and 3 for the first and second schematic views of a method of inserting video advertisement in a web page in accordance with a preferred embodiment of the present invention respectively, a user can browse a web page via a client 100 to send a web page browsing signal 101 to a web page server 200. Wherein, the client 100 can be a notebook computer, a personal computer, a tablet PC, a Smartphone, a personal digital assistant (PDA) or any device capable of connecting network. The web page server 200 is provided for storing different web page information, and the web page server 200 sends the web page information to the client 100 according to the web page browsing signal 101 transmitted from the client 100 and provides the web page information for the user's browsing. When the client 100 receives the web page information, the web page information includes an advertisement corresponding tag, so that the client 100 can send an advertisement connection signal 102 to an advertisement server 300 according to the advertisement corresponding tag. After receiving the advertisement connection signal 102, the advertisement server 300 analyzes and compares the relation condition such as the title, text, image or source of the web page information in the web page information. If the result analyzed and compared by the advertisement server 300 indicates that the relation condition corresponds to one of the video advertisement information, the advertisement server 300 will send an advertisement generating signal 301 to the client 100 to insert and display the corresponding video advertisement information A in the web page information as shown in FIG. 3. In FIG. 3, the content of the web page information is related to automobiles. Therefore, the corresponding inserted and displayed video advertisement information A is an automobile related video advertisement.

Wherein, when the corresponding video advertisement information A is inserted and displayed in the web page information, the advertisement server 300 sends an acknowledge signal 302 to the web page server 200 to notice that there is corresponding video advertisement information A being played on the web page information platform to serve as a basis for commercial transactions conducted between the advertisement server 300 and the web page server 200.

In summation of the description above, video advertisement information corresponding to the content of the web page information can be inserted and displayed in web page information in the method of inserting video advertisement in a web page according to the present invention in order to improve the advertisement viewing rate. The method of inserting video advertisement in a web page no longer requires reserving an advertisement display frame in the web page information, but inserts the advertisement display frame in the web page information only when it is necessary to insert video advertisement. Therefore, the present invention can avoid keeping the advertisement display frame even when the advertisement information cannot be linked or displayed correctly and prevent the web page information from having a black screen or texts indicating that there is no advertisement, so as to avoid a poor look of the web page.

The present invention breaks through the prior art and achieves the expected improvement as well as complying with the patent application requirements, and thus is duly filed for patent application.

While the invention has been described by means of specific embodiments, numerous modifications and variations could be made thereto by those skilled in the art without departing from the scope and spirit of the invention set forth in the claims.

What is claimed is:

1. A method of inserting video advertisement in a web page, comprising the steps of sending a web page browsing signal via a client to a web page server, thereby allowing the web page server to provide web page information to the client;
sending an advertisement connection signal via the client to an advertisement server when the client receives the web page information;
searching corresponding video advertisement information via the advertisement server according to a relation condition of the web page information; and
sending an advertisement generating signal to the client via the advertisement server for inserting and displaying the video advertisement information in the web page information.

2. The method of inserting video advertisement in a web page according to claim 1, wherein the web page information includes an advertisement corresponding tag to allow the client to send the advertisement connection signal to the advertisement server according to the advertisement corresponding tag.

3. The method of inserting video advertisement in a web page according to claim 2, wherein the advertisement corresponding tag is a program code included in a source file of the web page information.

4. The method of inserting video advertisement in a web page according to claim 1, wherein the relation condition includes a title, a text, an image or a web page source of the web page information.

5. The method of inserting video advertisement in a web page according to claim 1, further comprising a step of sending an acknowledge signal via the advertisement server to the web page server, when the video advertisement information is inserted and displayed in the web page information.

6. The method of inserting video advertisement in a web page according to claim 1, wherein the video advertisement information includes a movie, a video or an animation.

7. The method of inserting video advertisement in a web page according to claim 1, wherein the advertisement server includes an advertisement database for storing the video advertisement information.

8. The method of inserting video advertisement in a web page according to claim 1, wherein the advertisement server includes an analyzing unit for analyzing and comparing the relation condition to search the corresponding video advertisement information.

9. The method of inserting video advertisement in a web page according to claim 1, wherein when the advertisement, server sends the advertisement generating signal to the client, an advertisement display frame is inserted into the web page information and provided for displaying the video advertisement information.

10. The method of inserting video advertisement in a web page according to claim 9, wherein the client displays no advertisement display frame when the corresponding video advertisement information has not been found by the advertisement server.
